(19) United States
(12) Patent Application Publication
(10) Pub. No.: US 2025/0341854 A1
(43) Pub. Date: Nov. 6, 2025

(54) FAIL-SAFE RELEASE MECHANISM FOR USE WITH PATIENT POSITIONING SUPPORT APPARATI

(71) Applicant: Warsaw Orthopedic, Inc., Warsaw, IN (US)

(72) Inventors: Roger P. Jackson, Prairie Village, KS (US); Lawrence E. Guerra, Mission, KS (US); Michael A. Herron, Overland Park, KS (US)

(73) Assignee: WARSAW ORTHOPEDIC, INC, WARSAW, IN (US)

(21) Appl. No.: 19/270,843

(22) Filed: Jul. 16, 2025

Related U.S. Application Data
(63) Continuation of application No. 17/407,547, filed on Aug. 20, 2021, now Pat. No. 12,366,880.
Application No. 17/407,547 is a continuation of application No. 15/866,110, filed on Jan. 9, 2018, now Pat. No. 11,119,525.
Application No. 15/866,110 is a continuation of application No. 15/234,556, filed on Aug. 11, 2016, now Pat. No. 9,889,054.
(63) Continuation of application No. 15/234,556, filed on Aug. 11, 2016, now Pat. No. 9,889,054.
Application No. 15/234,556 is a continuation of application No. 13/507,618, filed on Jul. 13, 2012, now Pat. No. 9,561,145.
(60) Provisional application No. 61/633,215, filed on Feb. 7, 2012.

(51) Int. Cl. G05G 5/08; A61G 7/008; A61G 7/05; A61G 13/00; A61G 13/04; A61G 13/06; A61G 13/10; E04G 25/06

(52) U.S. Cl. CPC G05G 5/08; A61G 7/008; A61G 7/05; A61G 13/0036; A61G 13/0054; A61G 13/04; A61G 13/06; A61G 13/105; E04G 25/061; A61G 2200/325; A61G 2200/327; A61G 2203/70; A61G 2203/78; A61G 2210/50

(57) ABSTRACT

A fail-safe system for use with patient positioning support systems to prevent collapse of the patient support from the base.

### BACKGROUND OF THE INVENTION

The present invention is directed to a fail-safe system for use with patient positioning support systems, or surgical tables, that include a patient support table top, frame or imaging table removably connected with a supportive base structure. The fail-safe system prevents the improper disconnection of the patient support from the base. In some circumstances, a second patient support table top, frame or imaging table may also be removably attached to the base structure. The fail-safe system can be used with the second patient support table top, frame or imaging table, to prevent the improper disconnection of the second patient support table top from the base.

### SUMMARY OF THE INVENTION

In a first embodiment, a fail-safe apparatus is provided for use with a patient positioning support system having a patient support removably hingeably attached to a base by a removable connection pin, the patient positioning support system having a connection subassembly including a pair of longitudinally aligned spaced arms, each of the arms having inner and outer sides and an array of apertures extending between the inner and outer sides, the apertures being spaced along a length of the respective arm, each aperture of a first of the arms being paired with an opposed aperture of a second of the arms, the paired apertures cooperating so as to enable receipt of a locking rod, or connection pin, through both of the cooperating opposed apertures, the received locking rod having an orientation transverse to a longitudinal axis of each of the arms; the fail-safe apparatus including a pair of side members, each side member being attached to the outer side of one of the arms, each of the side members having an inner surface slidingly engaging an outer surface of the respective attached arm, a top end with a U-shaped notch; an array of through-bores downwardly spaced from the notch and also spaced along a length of the side member, the through-bores being spaced so as to be alignable with the apertures of the respective attached arm; and a pair of locking rods, or connection pins, receivable in the pairs of opposed through-bores and adjacent apertures, each locking rod including at least one circumferential locking notch, a first of the rods joining the arms with the connection subassembly; wherein disposition of a second of the rods in a lower pair of opposed through-bores causes at least one of the U-shaped notches to matingly engage the at least one locking notch of the first rod.

In a further embodiment, when the U-shaped notch and the locking notch are engaged, the first rod in substantially non-removable. In a still further embodiment, the side member through-bores are substantially aligned with adjacent arm apertures.

In a further embodiment, removal of the second rod disengages the U-shaped notch from the first rod locking notch, such that the first rod is removable from the associated apertures.

In a further embodiment, each side member includes a top through-bore joining the inner and outer surfaces; a nut member; and a bolt extending through the top through-bore and an adjacent aperture of the attached arm, so as to slidingly secure the side member to the respective arm. In a still further embodiment, the nut member engages the inner surface of the associated arm.

In a further embodiment, the second rod engages a connection member of the patient support, so as to hingeably attach the connection member to the base. In a still further embodiment, weight of a patient on the patient support substantially blocks removal of the second rod. In an even further embodiment, the weight substantially blocks removal of the first rod.

In a second embodiment, a method of using a fail-safe apparatus with a patient positioning support system is provided, the patient positioning support system having a patient support removably hingeably attached to a base by a removable connection rod, the patient positioning support system having a connection subassembly including a pair of longitudinally aligned spaced arms, each of the arms having inner and outer sides and an array of apertures extending between the inner and outer sides, the apertures being spaced along a length of the respective arm, each aperture of a first of the arms being paired with an opposed aperture of a second of the arms, the paired apertures cooperating so as to enable receipt of a locking rod through both of the cooperating opposed apertures, the received locking rod having an orientation transverse to a longitudinal axis of each of the arms; the method including the steps of providing a pair of arms, each arm having a side member attached to an outer side thereof; providing a pair of locking rods; inserting a first of the rods through an uppermost aperture of each of the arms and a through-bore of a rotation subassembly, so as to attach the arms to the rotation subassembly; inserting a second of the rods in a lower pair of cooperating arm apertures, wherein one of the apertures is located on each arm; matingly engaging a CT-shaped notch in at least one of the side members with a locking notch of the first rod, thereby substantially blocking removal of the first rod.

The drawings constitute a part of this specification and include exemplary embodiments of the present invention and illustrate various objects and features thereof.

### BRIEF DESCRIPTION OF THE DRAWINGS

FIG. 1 is a front perspective view of the fail-safe system of the present invention attached to an exemplary connection subassembly of a patient positioning support system, including a pair of side members and a pair of locking rods.

FIG. 2 is a side view of the fail-safe system of FIG. 1.

FIG. 3 is an enlarged side perspective view of the outer side of a first side member of the fail-safe system of FIG. 1.

FIG. 4 is a perspective view of the inner side of the first side member of FIG. 3.

FIG. 5 is an enlarged side perspective view of the outer side of a second side member of the fail-safe system of FIG. 1.

FIG. 6 is a perspective view of the inner side of the second side member of FIG. 5.

FIG. 7 is an enlarged perspective view of an upper portion of the side member of FIG. 3, showing greater detail thereof.

FIG. 8 is a perspective view of the upper portion of the side member of FIG. 7, including portions of the connection subassembly, to show greater detail of the position of the side member U-shaped notch with respect to the arm upper aperture when no locking rod is present (not shown) and the side member through-bores are misaligned with the arm apertures.

FIG. 9 is a cross-section of the fail-safe system of FIG. 8, showing greater detail thereof, the cross-section being taken on line 9-9 of FIG. 8.

FIG. 10 is a perspective view of the upper portion of the fail-safe system of FIG. 8, including the upper locking rod, to show greater detail of the position of the side member when a lower locking rod (not shown) is inserted below the upper locking rod and the side member through-bores and the arm apertures are aligned.

FIG. 11 is another view of the upper portion of the fail-safe system of FIG. 10, with the upper locking rod not shown, to show greater detail when a lower locking rod is inserted below the upper locking rod.

FIG. 12 is an enlarged cross-sectional view of the of the fail-safe system of FIG. 2, the cross-section being taken along line 12-12 of FIG. 2.

FIG. 13 is an enlarged view of an upper left-hand portion of the fail-safe system of FIG. 12.

FIG. 14 is an enlarged view of a lower left-hand portion of the fail-safe system of FIG. 12.

FIG. 15 is an enlarge perspective view of a locking rod of the fail-safe system of FIG. 1.

FIG. 16 is an enlarge view of a portion of the locking rod of FIG. 15.

FIG. 17 is a perspective view of a patient positioning support system usable with the fail-safe system of FIG. 1.

FIG. 18 is a perspective view of another patient positioning support system usable with the fail-safe system of FIG. 1.

FIG. 19 is an enlarged view of a portion of the patient positioning support system of FIG. 17.

### DETAILED DESCRIPTION OF THE ILLUSTRATED EMBODIMENTS

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

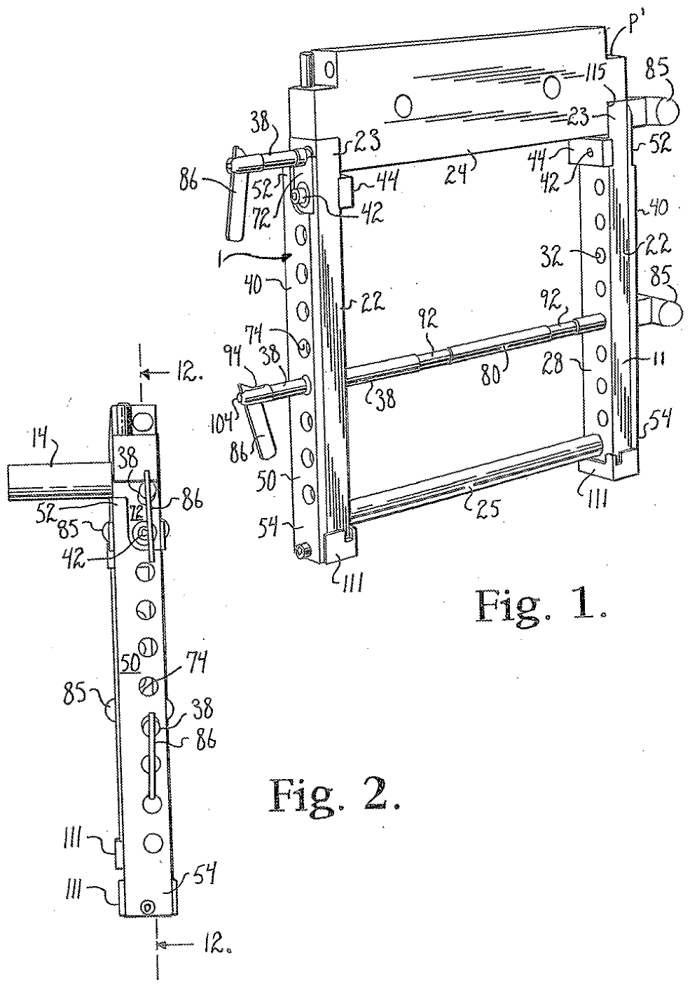

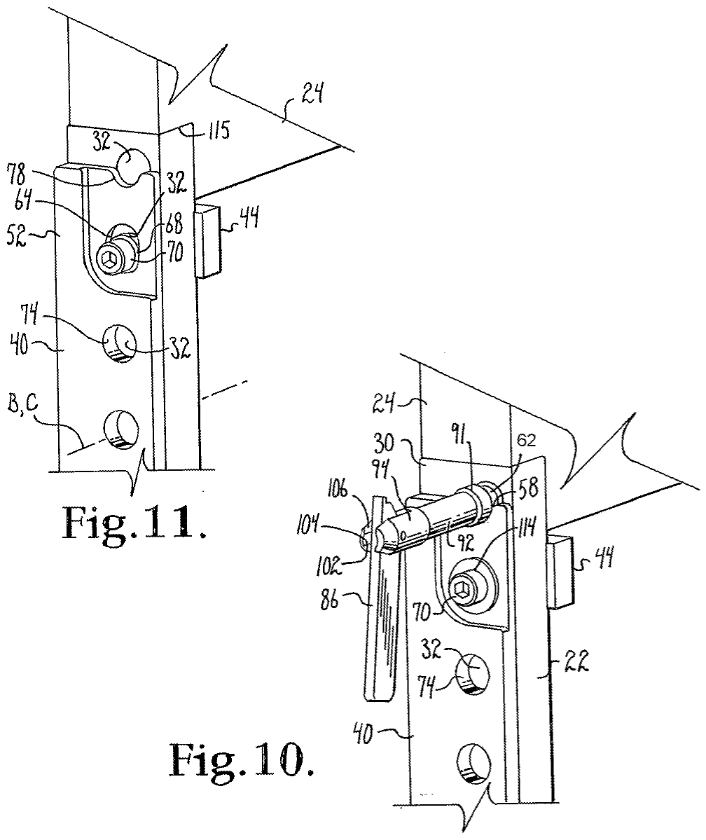

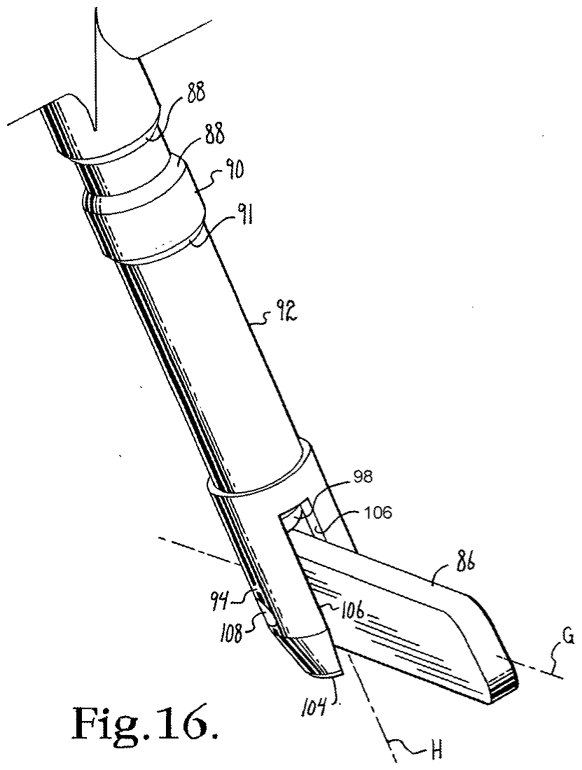

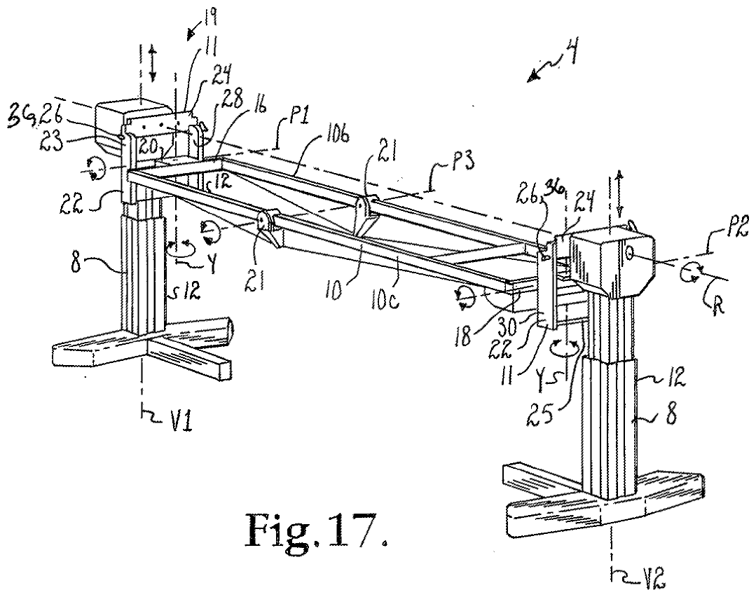

Referring now to the drawings, a fail-safe apparatus, generally denoted by the numeral 1, for use with a patient positioning support system, generally 4 and 5, or surgical table, shown in FIG. 1-16. Exemplary patient positioning support systems 4, 5 for rise with the present invention, are shown in FIGS. 17-19. Suitable surgical tables can be found in U.S. Pat. Nos. 7,152,261, 7,343,635, 7,565,708 and 7,739,762, US Publication Nos. 2009-0282614, 2011-0107517, 2011-0099716 and 2011-017516, and U.S. application Ser. No. 13/317,012, filed on Oct. 6, 2011 and entitled “Patient Positioning Support Structure all of which are incorporated herein by reference in their entirety.

Referring now to FIGS. 17-19, a exemplary patient positioning support systems 4, 5 includes a base 8 and a patient support 10. The base 8 includes at least one elevation subassembly 12, adapted for raising and lowering at least a portion of the patient support 10, such as to move a patient from a position parallel to the floor to a Trendelenburg position or to a reverse Trendelenburg position, and vice versa. The illustrated patient positioning support system base 8 includes an elevation subassembly 12 at each of the patient positioning support system head and foot ends 16, 18, respectively. In some circumstances, the elevation subassembly 12 includes a rotation subassembly, generally 14, for at least tilting the patient support 10 from side to side. In certain patient positioning support systems 4, 5, the rotation subassembly 14 is adapted to rotate the patient support 10 at least ±180° and preferably ±360°, so as to enable turning a patient (on the patient support 10) over from a prone position to a supine position, and vice versa. Some patient positioning support systems 4, 5 also include at least one translation subassembly (not shown).

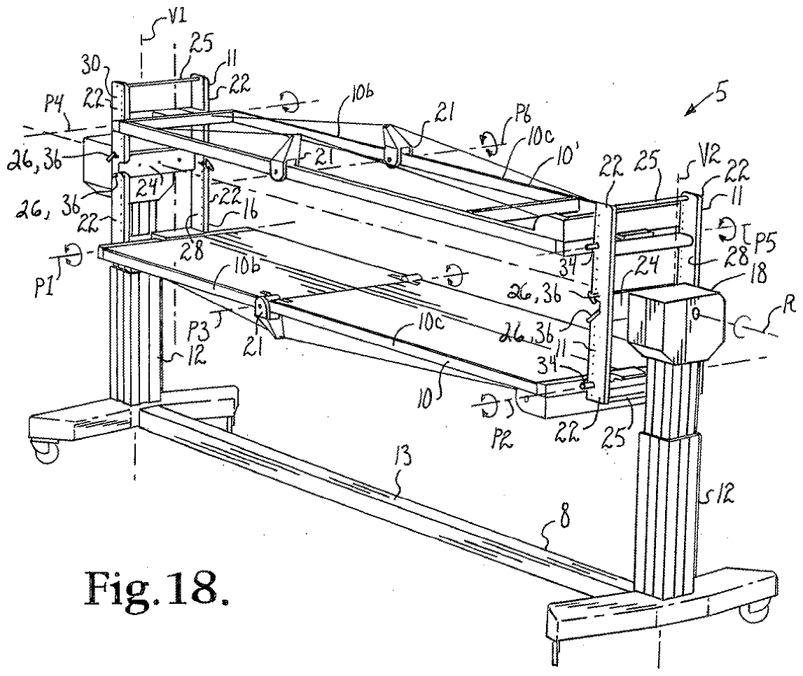

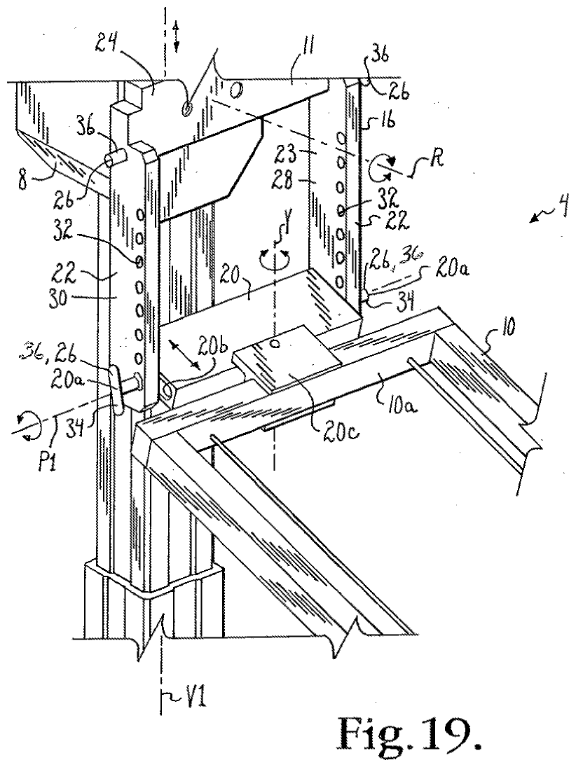

The base 8 includes a connection subassembly 20, for removable hingeable attachment of the patient support 10 thereto. The connection subassembly 20 includes a pair of longitudinally aligned, downwardly extending spaced arms 22 joined at their upper ends 23 to a rotator member 24 by an elongate connection pin 26, such as is shown in FIGS. 18 and 19. The arms 22 are spaced a distance suitable for attaching the patient support 10 to the connection subassembly 20. The lower ends of the arms 22 may be welded together with a metal bar or spacer 25, so as to form a substantially rigid, frame-like structure. In some patient positioning support systems 4, 5 the rotator member 24 is part of the rotation subassembly 14.

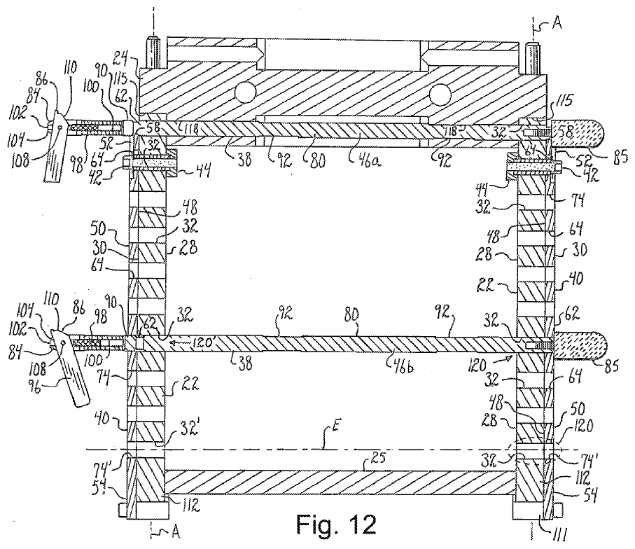

Each arm 22 has inner and outer sides 28, 30, respectively. An array of apertures 32, holes or bores, extends between the inner and outer sides 28 and 30. The apertures 32 are sized so as to enable passage of a connection pin 26 therethrough. As shown in FIGS. 1 and 12, the apertures 32 are spaced substantially evenly along the length of each arm 22. However, it is foreseen that the apertures may be spaced unevenly.

Referring to FIG. 12, each aperture 32 of a first of the arms 22 is coaxial with an opposed aperture 32 of the second of the arms 22, so as to form a pair of opposed apertures 32′. For example, axis E passes through the axial center of both of the paired apertures 32′. The paired apertures 32′ cooperate so as to enable insertion, or receipt, of a connection pin 26 through both apertures 32′ of the pair or alternatively a locking rod, such as is discussed below. The connection pin 26 that has been received through the pair of apertures 32′ is oriented substantially perpendicular to a longitudinal axis A of each of the arms 22. It is noted that the connection pins 26 are replaced by locking rods of the fail-safe apparatus 1, such as is described in greater detail below.

Referring to FIG. 18, a second patient support 10′ may be attached to the patient positioning support system 5, either prior to or during a surgical procedure. For example, the second patient support 10′ may be used for a “sandwich and roll” procedure, to transfer a patient in a supine position in a bed to a prone position on the surgical table. In another example, the second patient support 10′ may be an imaging table attached during a surgical procedure so as to take an image of the patient. Such a second patient support 10′ must be removed before the surgery can begin or continue. During disassembly of the patient support 10′ from the base 8, the upper and lower pins 34 must be removed in a particular order, so that the disassembly can be completed without injury to a patient or to the patient positioning support system 4, 5. Namely, the pin 34 connecting the patient support 10′ to the base 8, referred to herein as the lower or outer pin 34, must be removed prior to removing the pin 34 connecting the arms 22 to the rotator member 24, referred to herein as the upper or inner pin 34. Removing the pins 34 in an incorrect order can result in collapse of the patient support 10′ and the arms 22 onto the patient on the patient support 10, and damage to the patient positioning support apparatus 4.

It is noted that the terms “upper” and “lower” are used with reference to the orientation of the connection subassembly 20 shown in FIG. 1. When a second pair of arms 22 are also attached to the rotator member 24 at points P and P′, the terms “upper” and “lower” may be reversed. Thus, an “upper pin” is the pin 34 closest to the rotator member 24 and a “lower pin” is the pin 34 farthest from the rotator member 24.

Referring to FIGS. 18-19, the fail-safe apparatus 1 is attachable to the connection subassembly 20 of the patient positioning support system 4, 5, so as to substantially prevent disconnection of the arms 22, or removal of the upper, or inner, pin 34 before the lower, or outer, pin 36 has been removed from the arms 22. This is important because if the upper pin 34 is removed first, the end of the patient support 10 associated with that pin 34 will fall. A patient supported on the patient support 10 at the time such an accident occurs can be severely injured. Further, the patient positioning support system 4, 5 can be damaged.

In addition to being installed in newly manufactured patient positioning support systems 4, 5, the fail-safe apparatus 1 of the present invention is sized and shaped for retrofitting older patient positioning support systems 4, 5 that lack a mechanism to controlling which of the pins 26 is removed first, and are thus subject to such accidents.

Referring now to FIGS. 1-16, the fail-safe apparatus 1 of the present invention includes a pair of side members 40, or plates, bolts 42 and nut members 44 for attaching the side members 40 to the arms 22, and a pair of locking rods 46. The locking rods 46 replace the pins 34 and 36.

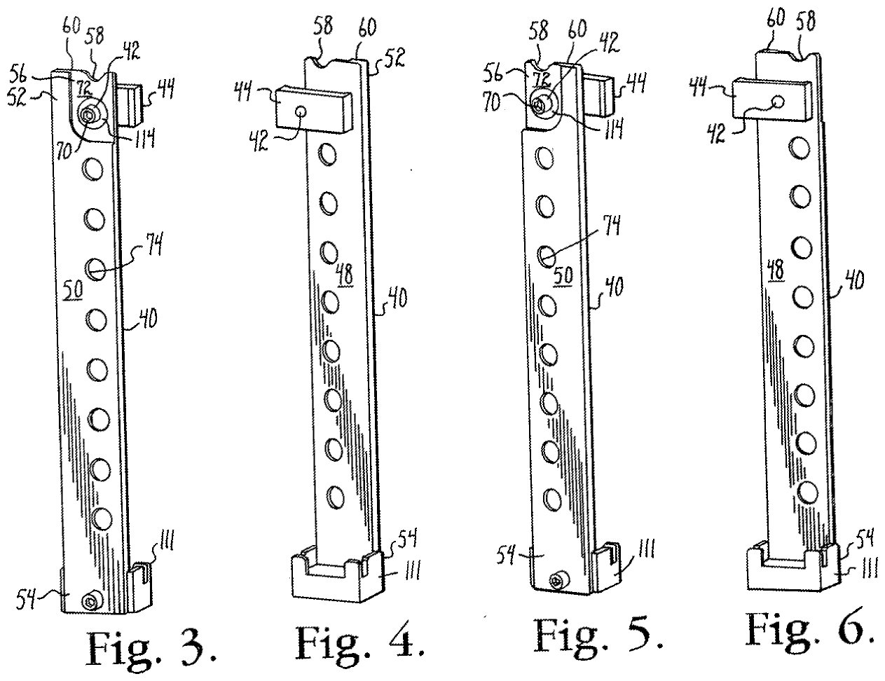

The individual side members 40, of a pair of side members 40, are mirror images of each other. This is most easily seen in FIGS. 3-6. Each side member 40 includes inner and outer surfaces 48, 50, respectively, and upper and lower ends 52, 54, respectively, also referred to as top and bottom ends. A side member 40 is attached to the outer side 30 of each of the arms 22. Accordingly, the inner surfaces 48 of the side members 40 slidingly engage the outer surfaces 30 of the respectively attached arms 22.

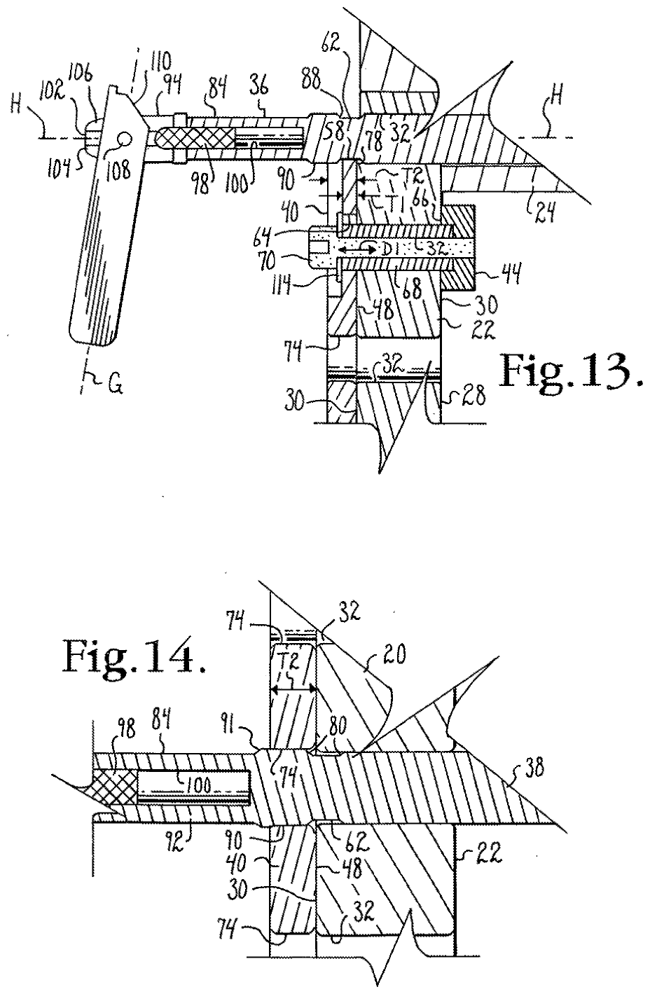

At its upper end 52, each side member 40 includes a cut-out portion 56. As is most easily seen in FIG. 13, the cut-out portion 56 has a thickness TI of about half the thickness T2 of the upper end 52 of the side member 40. The thickness TI of the cut-out portion 56, and also of the U-shaped notch 58, is substantially equal to a width of the locking notch. AU-shaped notch 58 is cut into the side member top surface 60. As will be described in greater detail below, the U-shaped notch 58 engages a locking notch 62 on one of the locking rods 46.

Each side member 40 includes a non-circular, asymmetric top through-bore 64 joining the inner and outer surfaces 48, 50. Though the exemplary top through-bore 64 of the illustrated embodiment is ovular in shape, other top through-bore shapes are foreseen, such as but not limited to circular, rectangular, and rectangular with rounded corners. The top through-bore 64 is spaced downwardly from the U-shaped notch 58 a distance sufficient to enable insertion of the bolt 42 through the top through-bore 64 and also through an adjacent aperture 32 of the attached arm 22, and then to engage or attach to the nut member 44, so as to slidingly secure the side member to the respective arm 22. As shown in FIG. 13, an inner surface 66 of the nut member 44 frictionally engages the inner surface 28 of the respective arm 22. A bushing 68 spaces the head 70 of the bolt a distance D from the surface 72 of the cut-out portion 56, wherein Dis substantially equal to TI, such that the side member 40 can slide up and down along the outer surface 30 of the arm 22. It is foreseen that, in some circumstances, the bolt 42 and the bushing 68 may be inserted through another of the arm apertures 32.

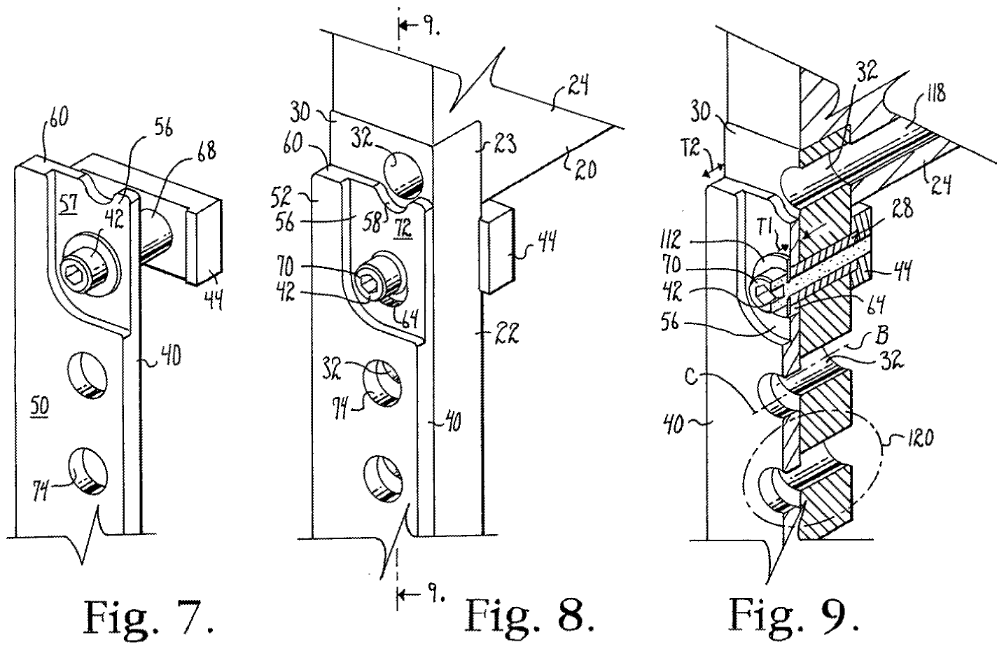

Still referring to FIGS. 1-16, an array of through-bores 74 is downwardly spaced from the U-shaped notch 58 and along a length of the side member 40. The through-bores 74 are spaced so as to be alignable with the apertures 32 of the respective attached arm 22. For example, as shown in FIG. 12, the through-bores 74′ are in axial alignment with the apertures 32′ and with respect to axis E. FIGS. 8-9 illustrate the position of the side member 40 with respect to the attached arm 40, when the through-bores 74 and apertures 32 are misaligned.

For convenience, a through-bore 74 and an adjacent aperture 32 may be referred to as a “bore-aperture pair” 76 (see FIGS. 9 and 12). Each bore-aperture pair 76 has two configurations, an “aligned configuration,” in which the central axis B of the aperture 32 is in alignment with the central axis C of the through-bore 70, such as is shown in FIG. 11 and a “misaligned configuration,” in which the central axes B, Care not in alignment, such as is shown in FIG. 9. As is discussed in greater detail below, when a bore-aperture pair 76 is in a misaligned configuration, such as is shown in FIG. 9, the locking rods 46 are not receivable through the bore-aperture pair 76. However, when a bore-aperture pair 76 is in an aligned configuration, such as is shown in FIG. 11, the locking rods 46 can be received therethrough.

Referring now to FIGS. 12-16, the fail-safe apparatus 1 of the present invention includes a pair of locking rods, 46, or connection pins, that are receivable in the bore-aperture pairs 76. In particular, a locking rod 46 can be received through the opposed bore-aperture pairs 76, wherein a first of the bore-aperture pairs 76 is associated with a first of the arms 22, and a second of the bore-aperture pairs 76 is associated with a second of the arms 22.

Each locking rod 46 includes a longitudinally extending body 80 with first and second ends 82, 84, respectively, a handle 85 joined to the body first end 82, and a spring-loaded latch 86 located at the second end 84. As discussed above, the locking rod 46 includes at least one locking notch 62, and preferably at least two locking notches 62. In the illustrated embodiment, a locking notch 62 is located near each of the body first and second ends 82, 84. As shown in FIGS. 12-14, the locking notches 62 are located along the length of the locking rod body 80 so as to be engageable the U-shaped notches 58 of the side members 40 when the locking rod 46 is inserted through the arm top aperture. Each locking notch 62 is cylindrical in shape, with a circular cross-section having a diameter reduced with respect to a diameter of the body 80. A chamfer 88 joins at least the second end-side of the locking notches 62 with an adjacent portion of the body 80 having the greater diameter.

Referring now to FIGS. 13 and 14, adjacent to the second end locking notch 46, is a locking ring member 90. The locking ring member 90 includes another chamfer 91 joining it with an adjacent narrowed portion 91. When the locking rod 46 is pushed through a bore-aperture pair 76 that is in a misaligned configuration, the chamfer 91 engages the side member 40, pushing or urging the side member 40 upward until the through-bore 74 and the aperture 32 become coaxially aligned and the bore-aperture pair 76 is in an aligned configuration (see FIG. 14). Urging the side member 40 upward causes the U-shaped notch 58 to engage the upper rod locking notch 62 (FIG. 13), which in turn locks the upper locking rod 46 in place, substantially preventing, or blocking, the removal of the upper locking rod 46 from the assembly 1. Accordingly, when the U-shaped notch 58 and the locking notch 62 are engaged, the upper locking rod 46 in substantially non-removable.

It is noted that, with respect to the lower locking rod 46, shown in FIG. 14, the portion of the side member 40 associated with the through-bore 74, through which the locking rod 46 is inserted, includes a thickness sufficient to prevent or block engagement of the locking notch 62 adjacent to the locking ring member 90. Accordingly, the through-bore 74 cannot engage the lower locking rod's locking notch 62. Furthermore, with respect to the upper locking rod 46, shown in FIG. 13, the side member cut-out portion 56 reduces the thickness of the side member 40 at the U-shaped notch 58, as is discussed above. Thus, instead of the locking ring member 90 of the upper locking rod 46 engaging the side member 40, the U-shaped notch 58 is urged upward into the locking notch 62, and into mating engagement therewith, such as when the side member 40 is urged upward by the lower locking rod 46. Accordingly, removal of the lower locking rod 46 from the assembly 1 enables disengagement of the U-shaped notch 58 from the upper locking rod locking notch 62, such that the upper locking rod 46 is then removable from the associated top arm apertures 32.

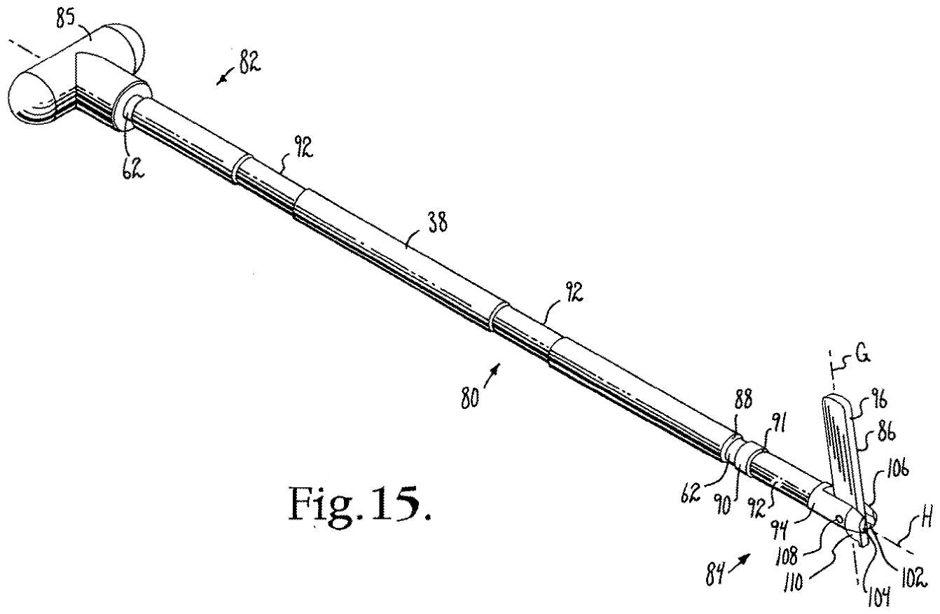

Referring again to FIG. 15, the locking rod body 80 includes at a diameter substantially equal to the diameter of the bore-aperture pairs 76, and least one reduced diameter portion 92 with a diameter that is reduced with respect to the diameter of the body 80. When the lower locking rod 46 is removed from the assembly 1, such as by pulling on the handle 85, the reduced diameter portions 92 engage and then disengage the associated through-bore 74 thereby acting as an alert signal to the operator that they are removing the lower locking rod 46. If a patient is on the patient support 10 when the locking rod 46 is pulled through the through-bore 74, the increased weight of the patient support 10 causes this engagement and then disengagement to make an enhanced bumping action signal that catches the operator's attention, thereby notifying the operator that they are removing the locking rod 46 supporting the patient. Further, the cooperation of the patient's weight and the reduced diameter portions 92 make it substantially difficult to remove the lower locking rod 46. Accordingly, the weight of a patient on the patient support 10 substantially blocks removal of the lower locking rod 46, which in turn substantially blocks removal of the upper locking rod 46 due to the associated engagement of the upper locking notches with the U-shaped notches.

Referring to FIGS. 13-16, the locking rod second end 84 includes a latch member 86 including a head member 94, a blade member 96 with a width W slightly smaller than the diameter of the bore-apertures pairs 76, and a spring-loaded set pin 98. As shown in FIG. 13, the head member 94 includes a longitudinally extending channel 100 that extends into the body 80 toward the body first end 82. The channel 100 includes an opening 102 at the end 104 of the head member 94, and a radial slot 106. The radial slot 106 is sized and shaped to receive the blade member 96 therein. A small axle 108 pivotably holds the blade member 96 within the slot 106 such that the blade member 96 can move between first and second positions. When in the first position, a longitudinal axis G of the blade member 96 is substantially parallel with a longitudinal axis Hof the locking rod 46, or the body 80. When in the second position, the blade member longitudinal axis G is substantially non-parallel with the body longitudinal axis H. When the locking rod 46 is pulled and the blade member 96 is in the first position, or the axes G and Hare substantially parallel, the locking rod 46 is removable from the assembly 1, such that the locking rod 96 can be pulled out of the assembly 1. However, when the locking rod 46 is pulled and the blade member 96 is in the second position, or the axes G and H are non-parallel, the blade member 96 engages the outer surface 50 of the adjacent side member 40, thereby substantially blocking removal of the blade member 96 from the assembly 1. Accordingly, when the blade member 96 is in the second position, the locking rod 46 is substantially non-removable.

The set pin 98 is spring loaded and engages the rear end 110 of the blade member 96, so as to urge the blade member 96 into the second position. To place the blade member 96 in the first position, so that the locking rod 46 can be removed from the assembly 1, the operator manually pivots the blade member 96 on the axle 108 until axes G and Hare substantially aligned.

In another embodiment, a method of using a fail-safe apparatus 1 of the instant invention is provided. The fail-safe apparatus 1, or assembly, is adapted for use with a patient positioning support system 4 and 5, such as is described above with respect to FIGS. 17-19.

In use, the side members 40 are attached to the arms of the connection subassembly 20. This is done by engaging the side member 40 with the arm 22, such that a side member foot portion 111 engages the arm lower end 112. Then, the top through-bore 64 of the side member 40 is aligned with the second from the top arm aperture 32. As is shown in FIGS. 8-9, the bolt 42 is inserted through a bushing 68, and then the bolt 42 and the bushing 68 are together inserted through the top through-bore 64 and the second from the top aperture 32. The bolt 42 is rotatably engaged with, or attached to, the nut member 44, which is located on the arm inner side 28. A washer 112 spaces the head 114 of the bolt 42 from the bushing 68, such that the bolt 42 and nut member 44 can be tightened, or snugged up, but there is still sufficient space for the cut-out portion 56 of the side member 40 to slide between the washer 112 and the arm outer side 30.

After the side members 40 are attached to the arms 22, the arms 22 are attached to the rotator member 27 in such an orientation that the side members 40 are outside of the arms 22, such as is shown in FIGS. 1 and 12. The upper locking rod 46a is inserted through the arm top apertures 32 and a rotator through-bore 116 extending through the rotator member 24, such that the arms 22 are secured to the rotator member 24.

After the arms 22, with attached side members 40, have been attached to the rotator member 40, the second, lower or outer locking rod 46b can be inserted through any of the remaining opposed pairs of bore-aperture pairs, generally 76a and 76b. While the second locking rod 46b is being attached to the fail-safe apparatus 1, the patient support 10 can be attached thereto, so as to attach the patient support 10 to the base 8 of the surgical table 4, 5.

Referring now to FIG. 12, and using the reference terms “right-hand” and “left-hand” to refer to the side members 40 associated with the right-and left-hand sides of the Figure, it is noted that when the second locking rod 46b is inserted through the right-hand bore-aperture pair 76a, the chamfer 91 and the locking ring member 90 urge the right-hand side member 40 upward. As a result, the right-hand side member CT-shaped notch 58 lockingly engages the locking notch 62 of the prior installed upper locking rod 46a, wherein the locking notch 62 is located adjacent to the handle 85 of the upper locking rod 46a.

Then, as the locking rod 46b is pushed through the second bore-aperture pair 76b, the chamfer 91 and the locking ring member 90 urge the left-hand side member 40 upward. The ring member 90 maintains the position of the left-hand side member 40 such that the bore-aperture pair 76b remains in an aligned configuration. Similar to as was described with respect to the right-hand side member 40, the left-hand side member U-shaped notch 58 lockingly engages the locking notch 62 of the prior installed upper locking rod 46b.

With reference to FIG. 12, it is noted that each locking rod 46 includes a length between the locking notch 62 adjacent to the handle 85 and the locking ring member 90 such that when the locking rod 46 is a lower locking rod 46b, the associated handle 85 abuts the outer surface 50 of the right-hand side member. Due to the greater thickness T2 of this portion of the right-hand side member and the relative length of the locking rod 46b, the locking ring member 90 to is located so as to be aligned with and engage the through-bore 32 of the left-hand bore-aperture pair 76b. Consequently, the locking notch 62 adjacent to the locking ring member 90 is substantially non-engageable by the left-hand side member 40. In contrast, with respect to the upper locking rod 46b, due to the reduced thickness TI of the side members 40 associated with the cutout-portions 56, both of the locking notches 61 of the upper locking rod 46a are engageable by the U-shaped notches 58 of the respective right-hand and left-hand side members 40. This configuration ensures that when the lower locking rod 46b is inserted into the fail-safe assembly 1, the upper locking rod 46a is substantially locked in place and therefore substantially non-removable.

To disassemble the patient support 10 from the base 8, the installation steps are simple reversed. First, the lower locking rod 46b is removed, with concomitant removal of the patient support 10 from the connection subassembly 20. Then, the upper locking rod 46a is removed, so that the arms 22, with the attached side members 40, are detached from the rotator member 24. It is not necessary to remove the side members 40 from the arms 22. Subsequent to the first installation, the side members 40 are generally left attached to the arms 22. However, the side members 40 may be removed from the arms 22 for cleaning, replacement, and the like.

It is to be understood that while certain forms of the present invention have been illustrated and described herein, it is not to be limited to the specific forms or arrangement of parts described and shown.

1-10. (canceled)

11. A method of using a patient positioning apparatus, the method comprising:
providing the patient positioning apparatus, the patient positioning apparatus comprising a base, a connection assembly, a connection subassembly, and a patient support;
supporting the base on a floor;
supporting the connection assembly relative to the floor by the base;
removably attaching the patient support to the base via the connection assembly; and
moving a portion of the connection subassembly relative to the connection assembly only after detaching the patient support from the base, so as to prevent the patient support from blocking the portion of the connection subassembly from being moved relative to the connection assembly.

12. The method of claim 11, wherein:
the connection assembly comprises a rotator portion, a first arm portion, a second arm portion, and a first key member; and
the method further comprises spacing the first arm portion and the second arm portion apart from one another by the rotator portion, and extending the first key member through portions of the rotator portion, the first arm portion, and the second arm portion to facilitate attachment therebetween.

13. The method of claim 12, wherein:
the rotator portion is rotatably supported on the base; and
the method further comprises rotating the rotator portion to correspondingly rotate the patient support when the patient support is attached to the connection assembly.

14. The method of claim 12, further comprising engaging the connection subassembly to the first key member to form a lock that secures the first key member in position relative to the first arm portion and the second arm portion.

15. The method of claim 12, further comprising sliding the portion of the connection subassembly relative to a respective one of the first arm portion and the second arm portion to engage the first key member to prevent removal of the respective one of the first arm portion and the second arm portion from the rotator portion.

16. The method of claim 12, further comprising forcing the portion of the connection subassembly into engagement with the first key member when the patient support is attached to the connection assembly to block relative movement between the connection subassembly and the connection assembly.

17. The method of claim 16, further comprising moving the portion of the connection subassembly relative to the connection assembly after detachment of the patient support from the connection assembly to disengage the portion of the connection subassembly from the first key member.

18. The method of claim 16, wherein:
the patient support comprises a second key member extendable through portions of the first arm portion, the second arm portion, and the patient support to facilitate attachment therebetween; and
the method further comprises forcing the connection subassembly into the engagement with the first key member when the second key member extends through the first arm portion, the second arm portion, and the portions of the patient support.

19. A method of using a patient positioning apparatus, the method comprising:
providing the patient positioning apparatus, the patient positioning apparatus comprising a base, a connection assembly, a connection subassembly, and a patient support;
supporting the base on a floor;
supporting the connection assembly relative to the floor by the base;
removably attaching the patient support to the base via the connection assembly;
blocking movement of a portion of the connection subassembly relative to the connection assembly when the patient support is attached to the base.

20. The method of claim 19, wherein:
the connection assembly comprises a rotator portion, a first arm portion, a second arm portion, and a first key member; and
the method further comprises spacing the first arm portion and the second arm portion apart from one another by the rotator portion, and extending the first key member through portions of the rotator portion, the first arm portion, and the second arm portion to facilitate attachment therebetween.

21. The method of claim 20, wherein:
the rotator portion is rotatably supported on the base; and
the method further comprises rotating the rotator portion to correspondingly rotate the patient support when the patient support is attached to the connection assembly.

22. The method of claim 20, further comprising engaging the connection subassembly to the first key member to form a lock that secures the first key member in position relative to the first arm portion and the second arm portion.

23. The method of claim 20, further comprising sliding the portion of the connection subassembly relative to a respective one of the first arm portion and the second arm portion to engage the first key member to prevent removal of the respective one of the first arm portion and the second arm portion from the rotator portion.

24. The method of claim 20, further comprising forcing the portion of the connection subassembly into engagement with the first key member when the patient support is attached to the connection assembly to block movement of the subassembly relative to the connection assembly.

25. The method of claim 24, further comprising moving the portion of the connection subassembly relative to the connection assembly after detachment of the patient support from the connection assembly to disengage from the first key member.

26. The method of claim 24, wherein:
the patient support comprises a second key member extendable through portions of the first arm portion, the second arm portion, and the patient support to facilitate attachment therebetween; and
the method further comprises forcing the connection subassembly into the engagement with the first key member when the second key member extends through the first arm portion, the second arm portion, and the portions of the patient support.

27. A method of using a patient positioning apparatus, the method comprising:
providing the patient positioning apparatus, the patient positioning apparatus comprising a base, a connection assembly, a connection subassembly, and a patient support;
supporting the base on a floor;
supporting the connection assembly relative to the floor by the base;
removably attaching the patient support to the base via the connection assembly;
moving a portion of the connection subassembly relative to the connection assembly only after detaching the patient support from the base, so as to prevent the patient support from blocking the portion of the connection subassembly from being moved relative to the connection assembly, and allow movement of the portion of the connection subassembly to facilitate separation of portions of the connection assembly.

28. The method of claim 27, wherein:
the connection assembly comprises a rotator portion, a first arm portion, a second arm portion, and a first key member; and
the method further comprises spacing the first arm portion and the second arm portion apart from one another by the rotator portion, and extending the first key member through portions of the rotator portion, the first arm portion, and the second arm portion to facilitate attachment therebetween.

29. The method of claim 28, further comprising engaging the connection subassembly to the first key member to form a lock that secures the first key member in position relative to the first arm portion and the second arm portion.

30. The method of claim 29, further comprising moving the portion of the connection subassembly relative to the connection assembly to disengage from the first key member after detachment of the patient support from the connection assembly to disengage the portion of the connection subassembly from the first key member, and facilitate separation of the portions of the connection assembly.
